(19) United States
(12) Patent Application Publication
(10) Pub. No.: US 2013/0270080 A1
(43) Pub. Date: Oct. 17, 2013

(54) ELECTRICAL INSTALLATION SWITCHING DEVICE HAVING A SWITCH POSITION INDICATION

(71) Applicant: ABB AG, Mannheim (DE)

(72) Inventors: Heiko STOLZ, Mannheim (DE); Dirk HAUCK, Epfenbach (DE)

(21) Appl. No.: 13/650,235

(22) Filed: Oct. 12, 2012

Related U.S. Application Data
(63) Continuation of application No. PCT/EP2011/001473, filed on Mar. 24, 2011.

(30) Foreign Application Priority Data
Apr. 20, 2010 (DE) 10 2010 015 825.9

(51) Int. Cl. H01H 9/16

(52) U.S. Cl. CPC H01H 9/16
USPC 200/308

(57) ABSTRACT

An electrical installation switching device includes a housing, a contact lever and a switch position indication, which is formed from a slide which is guided in the housing such that it can move longitudinally between a first indication position and a second indication position. The sliding movement of the slide is coupled to the movement of the contact lever. Latching means are provided on the slide and on the housing to detachably latch the slider to the housing in the first indication position, and thus to prevent inadvertent movement from the first indication position.

### RELATED APPLICATIONS

This application claims priority as a continuation application under 35 U.S.C. §120 to PCT/EP2011/001473, which was filed as an International Application on Mar. 24, 2011 designating the U.S., and which claims priority to German Application 10 2010 015 825.9 filed in Germany on Apr. 20, 2010. The entire contents of these applications are hereby incorporated by reference in their entireties

### FIELD

The present disclosure relates to an electrical installation switching device including a switch position indicator which can move longitudinally between a first indicating position and a second indicating position.

### BACKGROUND INFORMATION

A generic installation switching device can, for instance, include a known circuit breaker. In known circuit breakers, the indication of the switch position is given by the position of the switching knob. Identifiers such as O/I or off/on are printed onto this, and these identifiers can be read from the front when the device is assembled. If, as a result of damage, the contact elements of the circuit breaker become stuck together, it is no longer clear whether the circuit breaker is in the switched-on or switched-off position, since, due to the way in which the switch lock operates, the switching knob can now move independently of the contact lever.

For this reason, and because standards require a clear “On” indication if the contact elements stick together, a switch position indicator that is coupled to the contact lever has been created. For this purpose, a slider or a pivoting element is provided, where the slider or pivoting element moves back and forth between a first indicating position and a second indicating position behind an opening, which may be closed by transparent material, in the front face.

An installation switching device with a switch position indicator is disclosed in DE 103 42 545 B4, in which the switch position indicator is formed by a slider. The sliding movement of the slider is coupled to the movement of the contact lever by virtue of the fabrication of a lug on the contact lever and by virtue of the provision of an actuation space on the slider by means of two projections with a space between them. In order to actuate the slider, the lug engages with the actuation space, whereby an opening is arranged in the front face of the installation switching device and two indicating surfaces with different properties, such as areas of different color, are arranged on the slider. When the contact lever is in the switched-on position, and the contacts are therefore closed, the lug has pushed the slider into its first indicating position by acting on the first of the two projections. In this position, the first indicating surface is visible in the opening. When the contact lever is transferred to the switched-off position, and the contact elements are thus separated, the lug acts on the second of the two projections to push the slider into the second indicating position in which the second indicating surface is visible through the opening. If the indicating surfaces are, for example, colored green (for ON) and red (for OFF), it is possible to see through the opening whether the switch is on or off.

For reasons of practicable assembly, a certain distance is to be maintained between the two projections that border the actuation space on the slider. As a result, there is a greater or lesser degree of play between the two projections and the lug. In consequence, the above-mentioned manufacturing tolerances can mean that when the slider is in the switched-on position, it unintentionally moves somewhat in the direction of the second indicating position. In that case, both of the indicating surfaces may be partially visible through the opening at the same time, and an unequivocal indication of the switch position is no longer given. However, particularly when a fault has fused the contacts together, the switch position indicator should indicate the switched-on position.

### SUMMARY

An exemplary embodiment of the present disclosure provides an electrical installation switching device which includes a housing, a contact lever, and a switch position indicator including a slider configured to be guided in the housing so as to move longitudinally between a first indicating position and a second indicating position. A sliding movement of the slider is coupled to movement of the contact lever. The exemplary electrical installation switching device also includes latching means provided on the slider and the housing to releasably latch the slider to the housing in the first indicating position, and prevent inadvertent movement out of the first indicating position.

### BRIEF DESCRIPTION OF THE DRAWINGS

Additional refinements, advantages and features of the present disclosure are described in more detail below with reference to exemplary embodiments illustrated in the drawings, in which:

FIG. 1 shows a partial view of a circuit breaker according to an exemplary embodiment of the present disclosure with the contact lever in the switched-on position; and

FIG. 2 shows a schematic plan view of a slider according to an exemplary embodiment of the present disclosure.

### DETAILED DESCRIPTION

Exemplary embodiments of the present disclosure provide an improved installation switching device with a switch position indicator that ensures an unequivocal switch position indication should the contacts weld together.

An exemplary embodiment of the present disclosure provides an electrical installation switching device which includes a housing, a contact lever, and a switch position indicator including a slider configured to be guided in the housing so as to move longitudinally between a first indicating position and a second indicating position. A sliding movement of the slider is coupled to movement of the contact lever.

According to an exemplary embodiment of the present disclosure, means of latching are provided on the slider and on the housing, in order to releasably latch the slider to the housing in the first indicating position, and thereby prevent inadvertent movement out of the first indicating position.

According to an exemplary embodiment of the present disclosure, a first means of latching is provided in the form of a sprung element on the slider, and a second means of latching is provided on the housing in the form of a depression, whereby the sprung element latches into the depression in order to provide latching.

According to an exemplary embodiment of the present disclosure, the slider is guided in a guide groove in a wall of the housing in such a way that it can move longitudinally, and the depression is formed by a recess in the guide groove.

According to an exemplary embodiment of the present disclosure, the sprung element includes a leaf spring formed on the slider with a curvature that is bent away from the slider.

According to an exemplary embodiment of the present disclosure, the depression is formed as a concave hollow in the guide groove.

Exemplary embodiments of the present disclosure provide that in the first indicating position, which corresponds, for example, to the switched-on position, the latching action generates a releasable, secure seating for the slider. The slider is then no longer able to slip inadvertently in the direction of the second indicating position, and an unequivocal indication of the switched-on position is always provided, for example, in the case of welded contacts.

Elements that are identical, similar, or which function in identical or similar ways, are given the same reference numbers in the drawings.

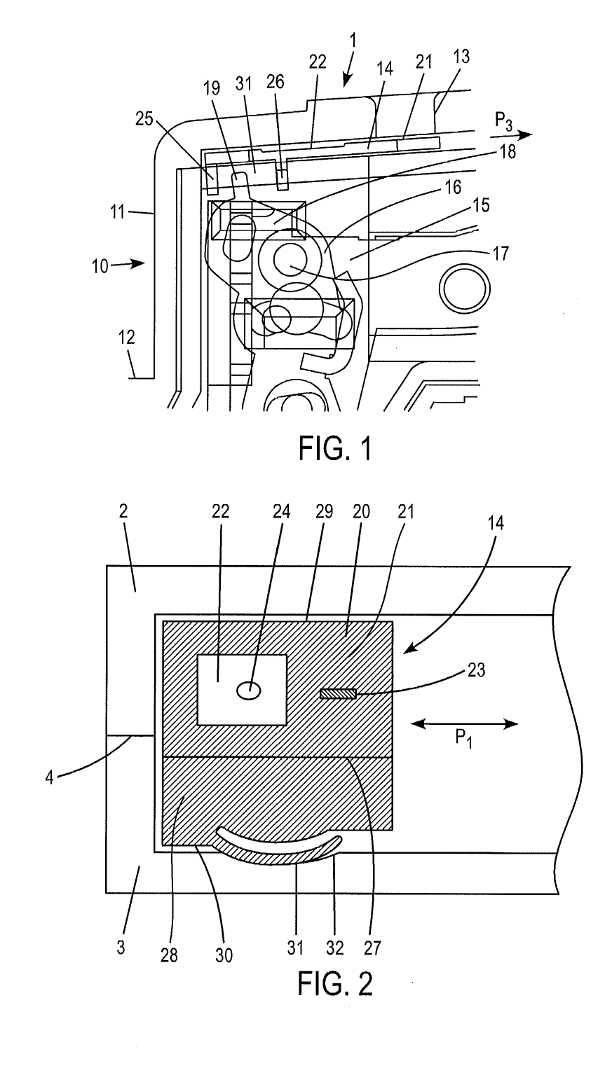

FIG. 1 illustrates a view of part of a circuit breaker 10, in which only the front face 1, the front side wall 11 and a small partial region of the rear face 12 of the housing are illustrated. There is an opening 13 in the front face 1, which is closed by a clear, transparent piece of plastic, for example, or which can also remain open, and which thus forms a viewing window. A slider 14 is located immediately behind the front face 1, and is able to move back and forth essentially parallel to the front face 1.

Parts of a switch lock 15 and a part of a movable contact lever 16, mounted so that it can rotate about an axis 17, are only partially visible. The contact lever 16 extends approximately perpendicularly to the front face 1 and in the area of the lever 18 that faces toward the front face 1 has a lug 19 that interacts with the slider 14.

The slider 14 has an approximately rectangular base plate 20 on which, on the side facing toward the observer, a first indicating surface 21 and a second indicating surface 22 are provided; the two indicating surfaces may have different colors—also see FIG. 2. The first indicating surface 21 here is, for example, green, and the second indicating surface 22 is, for example, red. The indicating surfaces also carry identifying marks 23, 24. The first indicating surface 21 carries a bar 23, representing a “ONE”, as an indicator that the contact lever 16 is in the switched-on position, and the second indicating surface carries a circle 24, representing a “ZERO”, as an indicator that the contact lever is in the switched-off position.

A longitudinal edge 27 of the plate 20 is adjoined by a guide plate 28, which operates together with the plate 20 to guide the slider 14 in the housing. The guidance is achieved here by sliding in guide grooves 29, 30, each of which is fabricated in one half of the housing at the front face 1. The housing is constructed as a box, including a first and a second housing half-shell 2, 3 which abut along a surrounding butting edge and are held together by a suitable means of fastening (see FIG. 2). FIG. 2 also shows how the plate 20 can be pushed longitudinally in the guide grooves 29, 30 in the direction of the arrow P1, parallel to the front face 1.

Two projections 25 and 26 are formed on the side of the plate 20 facing away from the observer, whereby the projections 25, 26 each constitute a kind of wall running transversely to the direction in which the lug 19 moves during a switching operation. An actuation space in which the lug 19 engages is formed between the two projections 25, 26.

In the switched-on position shown in FIG. 1, the first indicating surface 21 is thus visible through the opening 13, so indicating the switched-on state. When the contact lever 16 is moved out of the switched-on position shown in FIG. 1 into the switched-off position, it pivots clockwise around the axis 17. The lug 19 now carries the slider 14 over the projection 26, causing it to be pushed to the right in the direction of the arrow P3 until the second indicating surface 22 is visible through the opening 13, so indicating the switched-off position.

It can be seen in FIG. 1 that the actuation space between projections 25, 26 permits some play to the lug 19. It can be imagined that if no other measures are taken, the plate 20 could erroneously slip some way in the direction of the arrow P3 before it is stopped when the projection 25 meets the lug 19. However, a portion of the second indicating surface 22 would then be visible through the opening 13, and the indication of the switch position would no longer be unequivocal.

In order to prevent this, the longitudinal edge of the guide plate 28 that faces away from the base plate 20 carries a first means of latching in the form of a sprung element 31, which may be implemented as a leaf spring 31 formed on the slider and having a curvature that is bent convexly away from the slider. At a corresponding location, the guide groove 30 carries a second means of latching in the form of a depression 32, which may be made in the form of a concave hollow 32 in the guide groove 30.

The leaf spring 31 constitutes a spring integrated in the slider 14. This has the task of compensating for the tolerance or play between the actuation space and the lug 19, or at least of overcoming its disadvantageous effect. When the slider 14 indicates the switched-off position, and the contact lever 16 then swings back into the switched-on position, it carries the slider with it by means of the projection 25, pushing it into the end position as is illustrated in FIG. 1. This pushes the leaf spring 31 together, and the slider is pushed by the force of the spring. The stiffness of the spring is selected in such a way that there is not too much resistance to movement of the slider 14, allowing the contact lever 16 still to push the slider 14 effectively with the lug 19. A further effect is that any transverse tolerances that may also be present between the slider and the guide grooves 29, 30 can be compensated for, since the slider is pushed firmly into the guide groove 29 by the leaf spring 31.

When the slider 14 is pushed far enough for the leaf spring 31 to enter the area of the hollow 32, the leaf spring 31 settles into the hollow 32. The leaf spring 31 engages positively to a degree in the hollow 32, and the slider 14 is firmly seated. It is now no longer able to slip erroneously in the direction of the first indicating position.

On account of the convexly bent spring 31, the retaining force of the spring 31 in the hollow 32 is nevertheless not so large that when the contact lever 16 is swung back into the switched-off position it is no longer able to push the slider out of the position shown in FIG. 1. The latching of the slider by the leaf spring 31 in the hollow 32 is thus a releasable lock. The geometrical dimensioning of the leaf spring 31 and the hollow 32 can be used to adjust the retaining force in such a way as to satisfy the conflicting requirements for, on the one hand, effective fixing and, on the other, for easy release of the fixing.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

List of reference numbers

| | |
|---|---|
| 1 | Front face |
| 2 | First half-shell |
| 3 | Second half-shell |
| 4 | Butting edge |
| 10 | Circuit breaker |
| 11 | Front face |
| 12 | Rear face |
| 13 | Opening |
| 14 | Slider |
| 15 | Switch lock |
| 16 | Contact lever |
| 17 | Axis |
| 18 | Lever piece |
| 19 | Lug |
| 20 | Base plate |
| 21 | First indicating surface |
| 22 | Second indicating surface |
| 23 | Identifying mark |
| 24 | Identifying mark |
| 25 | Projection |
| 26 | Projection |
| 27 | Longitudinal edge of the plate |
| 28 | Guide plate |
| 29 | Guide groove |
| 30 | Guide groove |
| 31 | Sprung element |
| 32 | Depression, hollow |

What is claimed is:

1. An electrical installation switching device comprising:
a housing;
a contact lever;
a switch position indicator including a slider configured to be guided in the housing so as to move longitudinally between a first indicating position and a second indicating position, wherein a sliding movement of the slider is coupled to movement of the contact lever; and
latching means provided on the slider and the housing to releasably latch the slider to the housing in the first indicating position, and prevent inadvertent movement out of the first indicating position.

2. The electrical installation switching device as claimed in claim 1, wherein the latching means include:
a first latching means including a sprung element on the slider; and
a second latching means including a depression formed on the housing;
wherein the sprung element is configured to be latched into the depression to provide latching.

3. The electrical installation switching device as claimed in claim 2, wherein the slider is guided in a guide groove in a wall of the housing so as to move longitudinally, and
wherein the depression is formed by a recess in the guide groove.

4. The electrical installation switching device as claimed in claim 2, wherein the sprung element includes a leaf spring formed on the slider with a curvature that is bent away from the slider.

5. The electrical installation switching device as claimed in claim 3, wherein the depression is formed as a concave hollow in the guide groove.

6. The electrical installation switching device as claimed in claim 1, wherein the latching means include:
a sprung element formed on the slider; and
a depression formed on the housing;
wherein the sprung element is configured to be latched into the depression to provide latching.

7. The electrical installation switching device as claimed in claim 6, wherein the slider is guided in a guide groove in a wall of the housing so as to move longitudinally, and
wherein the depression is formed by a recess in the guide groove.

8. The electrical installation switching device as claimed in claim 6, wherein the sprung element includes a leaf spring formed on the slider with a curvature that is bent away from the slider.

9. The electrical installation switching device as claimed in claim 7, wherein the depression is formed as a concave hollow in the guide groove.
